(19) United States
(12) Patent Application Publication
(10) Pub. No.: US 2018/0319481 A1
(43) Pub. Date: Nov. 8, 2018

(54) Aircraft Spade Apparatus

(71) Applicants: Reed Chuda, Concord, MA (US); Warren Cilliars, Concord, MA (US)

(72) Inventors: Reed Chuda, Concord, MA (US); Warren Cilliars, Concord, MA (US)

(21) Appl. No.: 15/972,363

(22) Filed: May 7, 2018

Related U.S. Application Data
(60) Provisional application No. 62/501,803, filed on May 5, 2017.

(51) Int. Cl. B64C 9/30

(52) U.S. Cl. CPC B64C 9/30; B64C 2009/005

(57) ABSTRACT

An aileron counterbalance or aircraft spade apparatus disposed to afford optimal drag force, which particularly enhances the capability of an aircraft to spin, turn and dive more quickly and efficiently in aircraft races. The aircraft spade apparatus includes a rectangular shape and which exhibits a greater surface area and higher drag force characteristics.

### CROSS REFERENCE TO RELATED APPLICATION

This application claims the benefit of and takes priority from U.S. Provisional Patent Application Ser. No. 62/501,803 filed on May 5, 2017, the contents of which are herein incorporated by reference.

### BACKGROUND OF THE INVENTION

### Field of the Invention

The present system pertains to aircraft balance systems and control surfaces and more particularly systems and apparatuses for increasing drag force on an acrobatic aircraft when attempting entrance into a barrel roll scenario or other such aviation stunt maneuvers.

### Description of the Related Art

Annually, pilots take part in airplane races, such as the Red Bull Air Race, where they compete to navigate an obstacle course in the fastest time. The obstacles are challenging and require the plane to take sharp turns, spin and dive. Certain turns and obstacles indicate the angle at which the plane must pass over, through or around it. The aircraft needs to be able to adapt and recover from these moves quickly in order to be competitive in this race. The slightest improvements in the plane's ability to handle moves such as these can mean the difference between victory and defeat.

Airplanes traditionally use ailerons to assist in turning and rolling. An aileron is a hinged flight control surface usually forming part of the trailing edge of each wing of a fixed-wing aircraft. Ailerons are used in pairs to control the aircraft in roll, which normally results in a change in flight path due to the tilting of the lift vector. Pairs of ailerons are typically interconnected so that when one is moved downward, the other is moved upward: the down-going aileron increases the lift on its wing while the up-going aileron reduces the lift on its wing, producing a rolling movement about the aircraft's longitudinal axis. Ailerons are usually situated near the wing tip, but may sometimes also be situated near the wing root.

In the aviation arts, spades or aileron counterbalance mechanisms may normally be defined as flat plates, usually manufactured from metal material and normally attached to the aileron lower surface, ahead of the aileron hinge, by a lever arm. They reduce the force needed by the pilot to deflect the aileron and are often seen on aerobatic aircraft. As the aileron is deflected upward, the spade produces a downward aerodynamic force, which tends to rotate the whole assembly so as to further deflect the aileron upward.

The size of the spade determines how much force the pilot needs to apply to deflect the aileron and concurrent aileron apparatuses comprise downwardly-extending spade flanges which alter the basic singular planar profile of the aileron counterbalance spade. Concurrent aileron apparatuses also normally comprise tapered thickness on the main members as well.

### SUMMARY OF THE INVENTION

The instant system, series of apparatuses and method of usage, as illustrated herein, are clearly not anticipated, rendered obvious, or even present in any of the prior art mechanisms, either alone or in any combination thereof. Thus the several embodiments of the instant apparatus are illustrated herein.

In one embodiment, the instant system contemplates a novel aircraft control surface apparatus. In an additional embodiment, the instant system contemplates a novel aircraft spade or aileron counterbalance apparatus.

In one embodiment, the instant system contemplates a novel aircraft spade apparatus including an increased surface area in order to increase drag force.

In one embodiment, the instant system contemplates a novel aircraft spade apparatus including a differing shape in order to increase drag force.

The instant system further discloses a novel aircraft spade apparatus which is of a consistent thickness throughout.

aileron and concurrent aileron apparatuses comprise downwardly-extending spade flanges which alter the basic singular planar profile of the aileron counterbalance spade.

The instant system also discloses a novel aircraft spade apparatus, when used in combination with an aircraft oriented at specific angles of attack, allows the aircraft to perform a sharp, crisp roll and increases the overall roll rate of the aircraft.

It is also an objective of the instant system to disclose a novel aircraft spade apparatus that is composed of composite materials.

Another objective of the instant system is a novel aircraft spade apparatus for use in air races.

The instant system also discloses a novel aircraft spade apparatus that is easy to use, easy to install, light weight, inexpensive, and efficient.

There has thus been outlined, rather broadly, the more important features of the aircraft space apparatus in order that the detailed description thereof that follows may be better understood, and in order that the present contribution to the art may be better appreciated. There are additional features of the system that will be described hereinafter and which will form the subject matter of the claims appended hereto.

In this respect, before explaining at least one embodiment of the system in detail, it is to be understood that the system is not limited in its application to the details of construction and to the arrangements of the components set forth in the following description or illustrated in the drawings. The system is capable of other embodiments and of being practiced and carried out in various ways. Also, it is to be understood that the phraseology and terminology employed herein are for the purpose of description and should not be regarded as limiting.

These together with other objects of the system, along with the various features of novelty, which characterize the system, are pointed out with particularity in the claims annexed to and forming a part of this disclosure. For a better understanding of the system, its operating advantages and the specific objects attained by its uses, reference should be made to the accompanying drawings and descriptive matter in which there are illustrated preferred embodiments of the system.

The foregoing has outlined the more pertinent and important features of the present system in order that the detailed description of the system that follows may be better understood, and the present contributions to the art may be more fully appreciated. It is of course not possible to describe every conceivable combination of components and/or methodologies, but one of ordinary skill in the art may recognize that many further combinations or permutations are possible. Accordingly, the novel architecture described below is intended to embrace all such alterations, modifications, and variations that fall within the spirit and scope of the appended claims.

### BRIEF DESCRIPTION OF THE DRAWINGS

Advantages of the present system will be apparent from the following detailed description of exemplary embodiments thereof, which description should be considered in conjunction with the accompanying drawings, in which having thus described the system in general terms, reference will now be made to the accompanying drawings, which are not necessarily drawn to scale, and wherein:

FIG. 1 illustrates a front view of the one embodiment of the instant aircraft spade or aileron counterbalance apparatus layered above a concurrent state of the art aircraft spade.

FIG. 2 illustrates a front view of the one embodiment of the instant aircraft spade or aileron counterbalance apparatus layered below a concurrent state of the art aircraft spade.

FIG. 3 illustrates a front view of one embodiment of the aircraft spade apparatus.

FIG. 4 illustrates a front perspective view of the preferred embodiment of the aircraft spade apparatus.

FIG. 5 illustrates an environmental side view of the present apparatus during testing.

FIG. 6 illustrates an environmental side view of the present apparatus at the desired angle for use.

FIG. 7 illustrates a side view of one embodiment of the aircraft spade apparatus.

FIG. 8 illustrates top plan view of one embodiment of the aircraft spade apparatus illustrated in FIG. 7.

FIG. 9 illustrates a spade aerodynamics testing profile for one embodiment of the instant apparatus.

### DETAILED DESCRIPTION OF THE SEVERAL EMBODIMENTS

The detailed description set forth below in connection with the appended drawings is intended as a description of presently preferred embodiments of the system and does not represent the only forms in which the present system may be constructed and/or utilized. The description sets forth the functions and the sequence of steps for constructing and operating the system in connection with the illustrated embodiments.

In fluid dynamics, drag (sometimes called air resistance, a type of friction, or fluid resistance, another type of friction or fluid friction) is a force acting opposite to the relative motion of any object moving with respect to a surrounding fluid. This can exist between two fluid layers (or surfaces) or a fluid and a solid surface. Unlike other resistive forces, such as dry friction, which are nearly independent of velocity, drag forces depend on velocity. Drag force is proportional to the velocity for a laminar flow and the squared velocity for a turbulent flow. Even though the ultimate cause of a drag is viscous friction, the turbulent drag is independent of viscosity. Drag forces always decrease fluid velocity relative to the solid object in the fluid's path.

Utilizing these principles, the instant apparatus introduces a novel configuration including a rectangular structure which allows for a greater coefficient of drag for superior maneuverability during aerial acrobatics as illustrated herein.

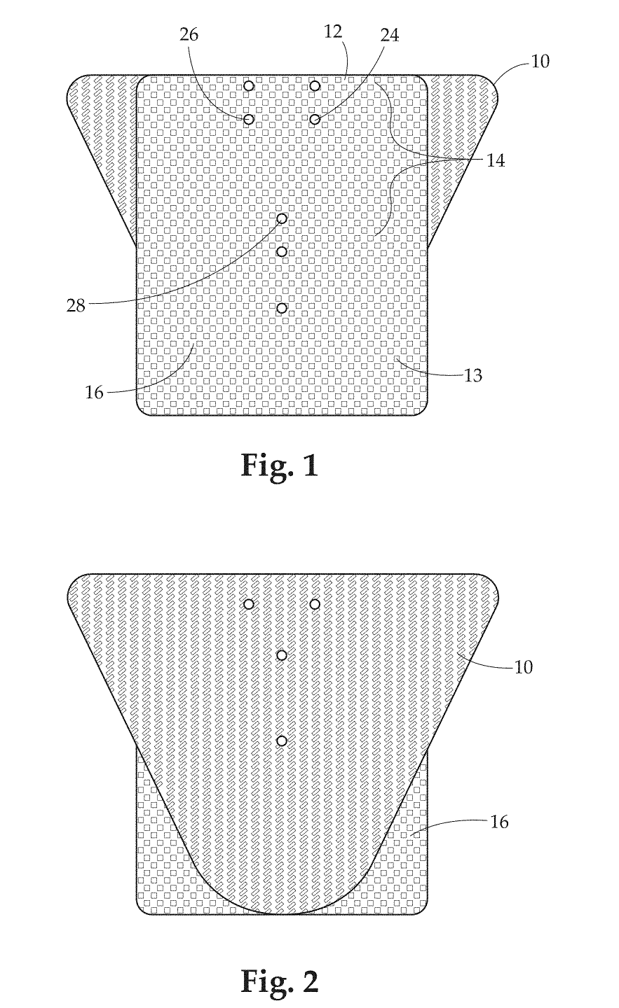

FIG. 1 illustrates a front view of one embodiment of the instant spade apparatus 16 or aircraft aileron counterbalance mechanism, layered over a concurrent state of the art embodiment of an aircraft spade apparatus 10 used within the industry, in order to illustrate the greater useful surface area gained by the instant spade apparatus 16. As illustrated, the concurrent embodiment 10 employees a triangular configuration and offers less overall surface area.

The surface of the aircraft spade apparatus 16 may comprise a laminate top coat 12. The main structure of the aircraft spade apparatus 16 is comprised of an under layer of twisted composite material 13 which is visible through the laminate top coat 12. The aircraft spade apparatus 16 additionally comprises a series or set of mounting apertures 14. Within the set of mounting apertures 14, at least two upper apertures 26, 24 may be located in proximity to upper portion of the aircraft spade apparatus 16 and at least one aperture, which may be located near the center of the apparatus, or a center aperture 28. The center aperture 28 is equidistant from the at least two upper apertures 26, 24.

FIG. 2 illustrates a front view of one embodiment of the instant aircraft spade 16 or aileron counterbalance apparatus layered below a concurrent state of the art aircraft spade 10 for comparative purposes to further illustrate the greater useful surface area gained by the instant system. Once again, the concurrently employed aircraft spade 10 features a triangular shape and inherently less surface area overall. The instant apparatus 16 is featured directly behind the concurrent embodiment 10 in order to illustrate the difference in shape and surface area.

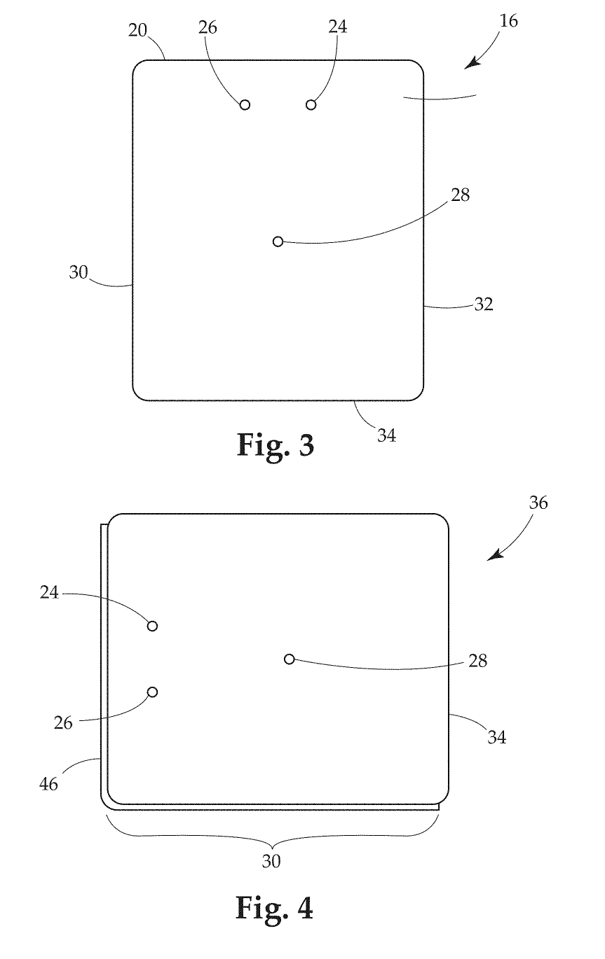

FIG. 3 illustrates a front view of one embodiment of the aircraft spade apparatus 16. Upper apertures 26, 24 are illustrated and located below the upper portion 20 of the aircraft spade apparatus 16. In one embodiment, the upper apertures 26, 24 may be located at one-fourth (¼) inch below the upper portion 20 of the present aircraft spade apparatus 16, in order to allow for proper fracture and stress/strain properties surrounding upper apertures 26, 24.

In one embodiment, each individual upper aperture 26 and 28 may be at a specified distance 22 away from the nearest vertical side of the present apparatus 16. In one embodiment, the specified distance 22 away from the nearest vertical side of the present apparatus 16 may be two and one quarter inches (2¼) inches.

The center aperture 28 should be located equidistantly from the vertical sides in order to allow for proper fracture and stress/strain properties. In one embodiment, the center aperture 28 may be located three (3) inches from the vertical sides at in length 32 from the vertical sides of the instant apparatus 16.

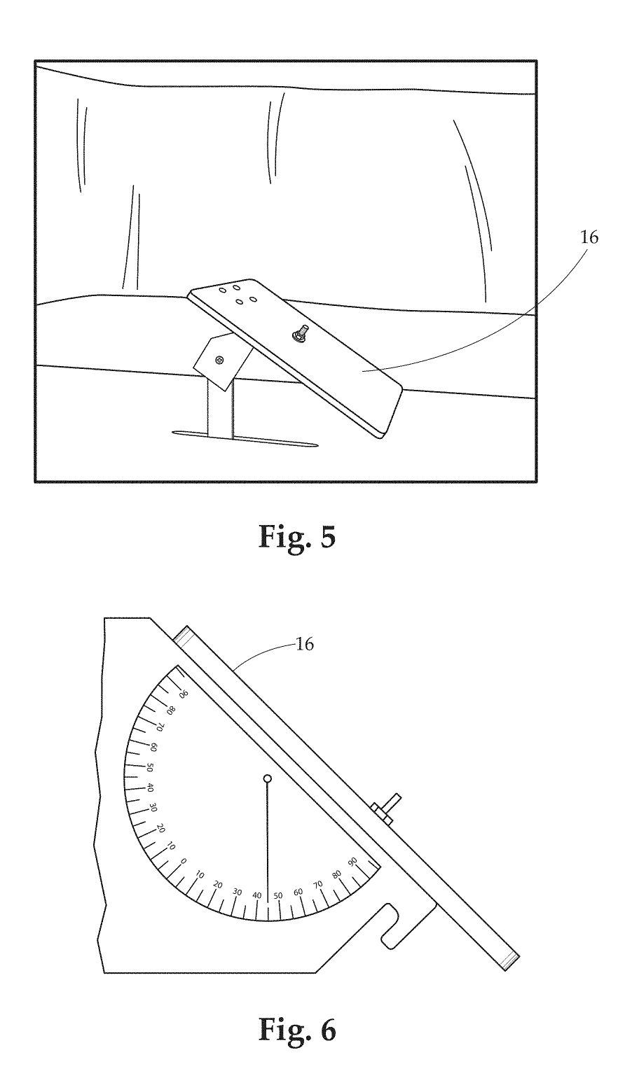

FIG. 4 illustrates a front perspective view of one embodiment of the aircraft spade apparatus 16. In this embodiment, the bottom and top edges 34 are shown to be six and one quarter (6¼) inches in length. The two vertical sides 30 are shown to be seven and one quarter 7¼ inches in length. Thus, the aircraft spade apparatus 16 employees a uniform thickness throughout, and in one embodiment may be shown to be ¼ inches 46.

FIG. 5 illustrates a side view of the present apparatus 16 constrained for wind tunnel testing.

FIG. 6 illustrates a side view of the present apparatus 16 constrained for wind tunnel testing at a desired angle of forty-five degrees (45°).

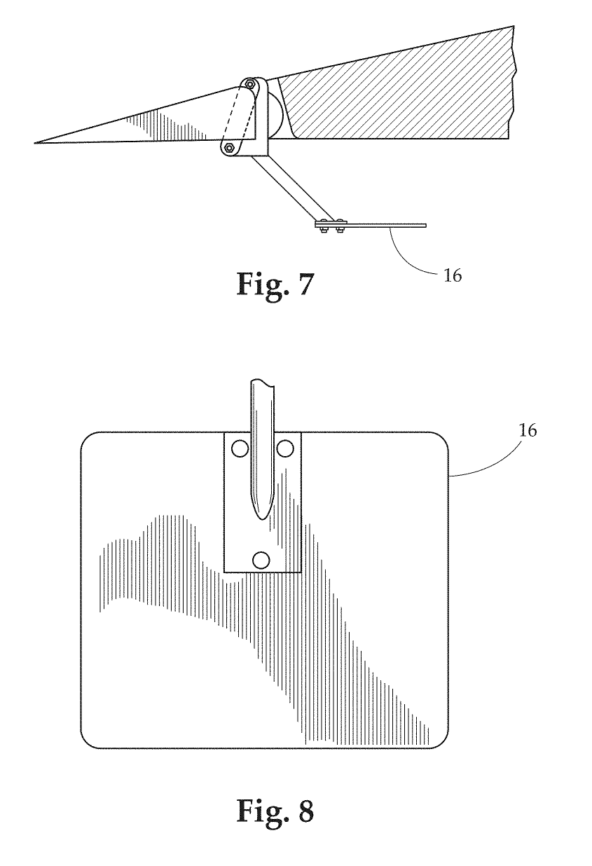

FIG. 7 illustrates a side view of one embodiment of the aircraft spade apparatus 16 embarked for usage and attached to the lower portion of a fuselage of a plane.

FIG. 8 illustrates top plan view of the embodiment of the aircraft spade apparatus 16 of FIG. 7.

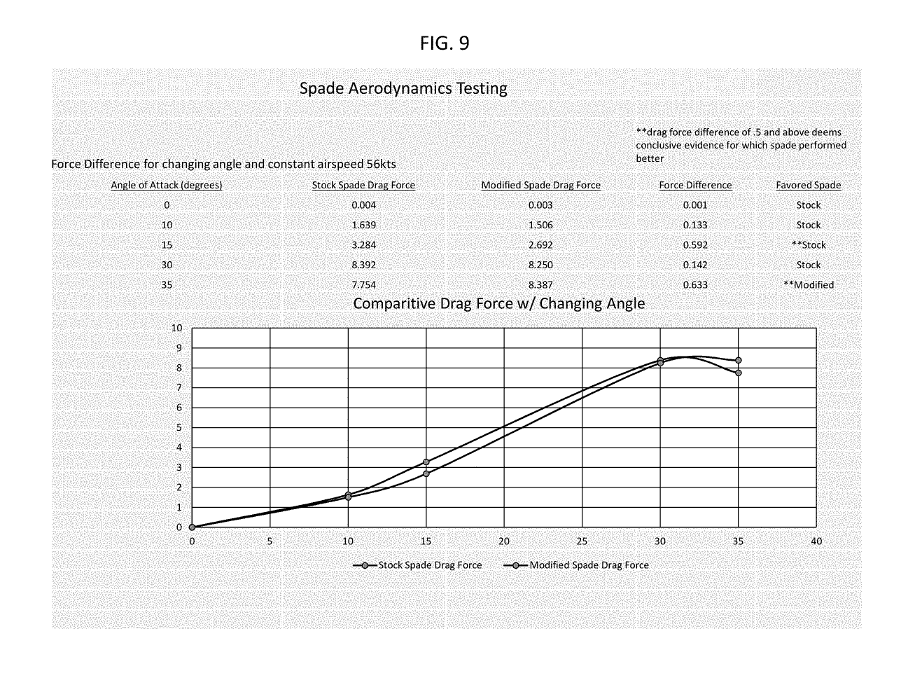

FIG. 9 illustrates a spade aerodynamics testing profile for one embodiment of the instant apparatus.

1. An aileron counterbalance apparatus comprising:
a linearly disposed rectangular structure comprising an under layer of twisted composite material, a laminate top coat and a set of mounting apertures.

2. The aileron counterbalance apparatus of claim 1 wherein the under layer of twisted composite material is visible through the laminate top coat.

3. The aileron counterbalance apparatus of claim 1 wherein the aileron counterbalance apparatus comprises no downwardly-extending spade flanges.

4. The aileron counterbalance apparatus of claim 1 wherein the aileron counterbalance apparatus comprises a uniform thickness.

5. The aileron counterbalance apparatus of claim 1 further comprising a set of mounting apertures.
